(19) United States
(12) Patent Application Publication
(10) Pub. No.: US 2019/0367672 A1
(43) Pub. Date: Dec. 5, 2019

(54) USE OF A MODIFIED POLYAMIDE FOR MANUFACTURING ANTI-BACTERIAL TEXTILE PRODUCTS

(71) Applicant: GOLDEN LADY COMPANY S.P.A., Castiglione Delle Stivier (IT)

(72) Inventors: Nerino GRASSI, Castiglione Delle Stiviere (IT); Mauro ZALTIERI, Castelnuovo Di Asola (IT)

(21) Appl. No.: 16/483,917

(22) PCT Filed: Jan. 31, 2018
(86) PCT No.: PCT/IB2018/050589

§ 371 Date: Aug. 6, 2019

(30) Foreign Application Priority Data
Feb. 7, 2017 (IT) 102017000013100

(51) Int. Cl. C08G 69/48; C08G 69/14; C08G 69/26; C08G 69/40; C08L 77/02; C08L 77/06; D01F 6/82

(52) U.S. Cl. CPC C08G 69/48; C08G 69/14; C08G 69/26; C08G 69/40; D10B 2401/13; C08L 77/06; D01F 6/82; D10B 2331/02; D10B 2331/06; C08L 77/02

(57) ABSTRACT

A new use of at least a polyetheramine in a polyamide containing nylon is disclosed, in order to impart, or increase, anti-bacterial properties of polyamide.

### TECHNICAL FIELD

The present invention relates to the field of polymers. In particular, aspects of the present invention relate to improvements to polymers for manufacturing threads, fibers and synthetic yarns for manufacturing textile products, for example woven, knitted, non-woven articles or other textiles made with synthetic threads, fibers or yarns.

Embodiments described herein relate to improvements to polyamides.

### STATE OF THE ART

In manufacturing textile articles, especially in the clothing industry, there is an increasing need for imparting antimicrobial or anti-bacterial features to threads, yarns or fibers used for manufacturing the articles, as well as to the clothes made with these semi-finished articles. The need for imparting anti-bacterial or bacteriostatic features to the semi-finished products for manufacturing textile articles is linked both to hygienic-medical reasons and to non-pathological side effects, connected to the presence and proliferation of microorganisms in textile articles for clothing. The hygienic-medical reasons refer to the need of reducing the transmission of pathogens through textile articles, for example in hospital or industry environments. Among the side effects due to the presence and proliferation of microorganisms, in particular on clothes, there is the formation of bad smell.

Many studies have been carried out for realizing polymers, in particular polymers suitable for knitting and weaving for manufacturing textile articles made of synthetic fibers and having biocidal ability. In general, the various methods for imparting antibacterial or bacteriostatic features to the polymers are subdivided into three main categories:
biocidal polymers: these are polymers having an intrinsic antimicrobial activity, usually based on the use of polycations, having the ability to kill microorganisms by acting on the cell membrane thereof;
polymeric biocides: they are polymers intrinsically devoid of antimicrobial activity, to which biocidal molecules are functionally bonded. Usually, the polymeric biocides have lower effectiveness than the biocidal polymers, due to their steric hindrance. As known, steric hindrance is the effect that the spatial distribution of atoms in a molecule structure may have in retarding or preventing chemical reactions. The molecules with biocidal characteristics used in these cases are complex, have low thermal stability, are expensive and, in general, difficult to be deal with;
biocide-releasing polymers: these are polymers without antibacterial properties, to which biocidal molecules have been applied, that are released over time. They are, essentially, polymeric matrixes charged with biocidal molecules trapped into the matrix with different methods. These polymers have many disadvantages, due to the fact that the released biocides are pollutants, and that the biocidal content of the polymer is exhausted over time and shall be recovered.

A wide review on the recent developments of antimicrobial polymers can be found in: Madson R. E. Santos et al., “Recent Developments in Antimicrobial Polymers: A review”, in Materials, 2016, 9, 599; doi:10.3390/ma9070599 (www.mdpi.com/journal/materiaIs); Xan Xue et al., “Antimicrobial Polymeric Materials with Quaternary Ammonium and Phosphonium Salts”, in International Journal of Molecular Sciences, 2015, 16, 3626-3655; doi: 10.3390/ijms16023626 (www.mdpi.com/journaIs/ijms); Diana Santos Morais et al. “Antimicrobial Approaches for Textiles: From Research to Market”, in Materials, 2016, 9, 498; doi:10.3390/ma9060498, (http://www.mdpi.com/journal/materials); Felix Siedelbiedel et al, “Antimicrobial Polymers in Solution and Surfaces: Overview and Functional Principles”, in Polymers 2012, 4, 46-71; doi:10.3390/polym4010046 (www.mdpi.com/journal/polymers); Sheila Shahidi et al, “Antibacterial Agents in Textile Industry”, in “Antimicrobial Agents”, edito da Varaprasad Bobbarala, ISBN 978-953-51-0723-1, 12 Sep. 2012, capitolo 19, pagg. 388-406.

As it is clearly apparent from the technical-scientific literature listed above, manufacturing polymers with antibacterial properties has significant technical difficulties and/or inconveniences in the step of fiber formation or in using the semi-finished product and the fabric made with this product.

There is therefore a continuous need for more economical solutions, that are also more effective and less polluting, for manufacturing textile articles with anti-bacterial properties.

More in general, there is a need for synthetic resins having anti-bacterial or bacteriostatic properties, including antifungal properties.

### SUMMARY OF THE INVENTION

It has been surprisingly found, and forms an object of the present invention, that a specific change of polyamide, and in particular of polyamide 66 and polyamide 6, imparts this polymer anti-bacterial and antifungal properties. In the present description and the attached claims, the term “antibacterial properties” generally refers to the ability of reducing or inhibiting the proliferation of microorganisms, especially bacteria, microbes, fungi, viruses.

More in particular, it has been found that polyamides containing nylon, in particular for example nylon 6 and nylon 66, acquire or improve their antibacterial properties if a polyetheramine is introduced into the polyamide molecules. It has been found that the polyamide containing polyetheramine moieties bonded to the molecules of nylon, has a greater bacteriostatic ability than the same polyamide polyetheramine moieties.

WO2014/057364 and WO2015/001515 disclose methods for manufacturing modified polyamides, comprising nylon and a polyetherdiamine, to increase the moisture regain, i.e. the ability of absorbing and retaining humidity. In particular, these modified polyamides are suggested to increase the textile feel of fabrics and clothes made thereof. However, these prior art documents do not demonstrate any effect of the polyetheramine on the antibacterial properties of the modified polyamide.

According to one aspect, the present invention relates to the use of at least one polyetheramine in a polyamide containing nylon, to increase the antibacterial properties of the polyamide, i.e. to achieve a modified polyamide that has greater antibacterial ability than the same polyamide without polyetheramine. The polyetheramine and the nylon are bonded together with covalent bonds and form part of the polyamide polymer chain, so that the antibacterial properties imparted by the polyetheramine are stable over time and long lasting, even when the polymer is subjected for example to repeated washing and/or thermal treatments, as typically occurs when the polyamide is used for manufacturing textile articles, such as garments, clothes or the like.

The mechanisms, through which the surprising effect on which the present invention are obtained, are not entirely clear. Probably, but without limiting the scope of the present disclosure, amino groups present in the polyetheramine hinder the proliferation of micro-organisms, imparting bacteriostatic features to the modified polyamide.

According to a further aspect, the invention relates to the use of a polyamide fiber or yarn containing nylon and a polyetheramine for manufacturing a textile article with antibacterial properties, including antifungal properties, in particular but not exclusively a garment.

According to a more general aspect, the invention relates to the use of polyamide containing nylon and a polyetheramine for manufacturing an article with antibacterial properties, including antifungal properties, for all applications, in addition to the textile industry, in which the antibacterial properties of the modified resin can be useful. The choice of the basic polymer or copolymer can be based on the end use to which the modified resin is intended.

As the presence of bacteria on fabrics and garments causes the formation of unpleasant odors, the uses and the methods described herein to impart or increase the antibacterial ability of polyamide also represent uses and methods for reducing or preventing the formation of unpleasant odors in a garment made with fibers or threads containing said polyamide.

The invention also relates to the use of a semi-finished textile article in the form of a fiber or yarn, containing a polyamide containing nylon and a polyetheramine, in the manufacturing of a textile article, for example a garment, to prevent or reduce the formation of bad smell.

In general, the fiber or yarn may contain, in addition to the polyamide containing nylon and polyetheramine, also other substances, for example it may comprise a percentage of a polymer free of polyetheramine. The fiber or yarn may be, for example, a bicomponent fiber or yarn.

According to a further aspect, the invention relates to a method for producing a polyamide containing nylon, where polyetheramine is introduced into the polymer structure of the polyamide to increase the antibacterial properties of the polyamide. The characteristics of the nylon and the polyetheramine are advantageously selected so that the polyamide is able to be extruded and transformed into fiber or yarn for use in the production of textile articles, in particular but not exclusively for clothing.

A method is also disclosed for manufacturing a semi-finished textile product, in the form of yarn or fiber, containing a polyamide containing nylon, wherein polyetheramine is introduced into the polymer structure of the polyamide to increase the antibacterial properties of the polyamide.

A method is also disclosed for producing a textile semi-finished product, in the form of yarn or fiber, containing a polyamide containing nylon, wherein polyetheramine is introduced into the polymeric structure of the polyamide to reduce the formation of unpleasant odors.

The method may include the step of adding polyetheramine during the polymerization step. An object of the present invention is therefore also the use of a polyetheramine in a step of a polymerization method, to form a polyamide containing nylon and polyetheramine having improved antibacterial properties.

In other embodiments, the method can provide the step of contacting the polyetheramine with polyamide containing nylon and causing the reaction between the polyetheramine and the polyamide with the reaction of carboxyl end groups of the nylon with amino groups of the polyetheramine molecules and consequent replacement of the carboxyl end group with the polyetheramine moiety.

An object of the present invention is therefore also the use of a polyetheramine in a method for modifying a polyamide containing nylon, and introducing at least one polyetheramine into the chemical structure thereof, i.e. in its polymeric chain, to impart antibacterial ability of the modified polyamide containing polyetheramine or increase said ability.

The invention also concerns a method for manufacturing a textile article comprising the step of transforming a semi-finished product in the form of a fiber or yarn into a textile structure, such as a non-woven fabric, a woven fabric, or a knitted fabric, wherein the semi-finished product comprises polyamide containing nylon and polyetheramine, to increase the antibacterial properties of the textile structure.

Preferably, the polyetheramine used in the polyamide has at least two amine end groups (NH₂), one of which is used for bonding with a nylon molecule of the polyamide and the other one remains available in the resulting polymer chain.

According to embodiments disclosed herein, the polyetheramine is preferably a polyetherdiamine or a polyethertriamine.

Preferably, the nylon is nylon 6 or nylon 66, or a copolymer of nylon 6 and nylon 66.

The use of polyamides modified with polyetheramines allows to obtain antibacterial properties in yarns and fibers by means of a process that can be easily implemented at industrial level. In particular, in fact, the process conditions for introducing the polyetheramine into the polyamide chain are not substantially different from those used for producing the polyamide. Moreover, this has the undoubted advantage of economic efficiency compared to other currently known industrial processes, aimed at achieving similar effects.

While in various production processes the amine group can bind in end position in the polymer chain, it is also possible that the amine group is in an intermediate position along the polymer chain.

The use of nylon 6 and nylon 66 modified with amino groups is particularly useful for manufacturing bacteriostatic or antibacterial textile articles. These articles can be destined to the field of clothing as well as to other fields, such as for example for use in the furniture field, in the automotive industry, or in the production of textiles for homes, hospitals or communities, such as towels, sheets, gowns, etc.

Moreover, the antibacterial or bacteriostatic properties imparted to the polyamide modified by the amino groups can also be useful in fields other than the textile industry. In some cases, a different modified polyamide with bacteriostatic and/or antibacterial properties can be used in fields where the synthetic resin must have different physical properties than those required for the fiber or yarn. For example, in the dental field resins are used for the production of dental prostheses, dental appliances, dental splints, dental bites and the like. In these applications it is necessary to impart the synthetic resin particular properties of mechanical strength and stiffness. Antibacterial properties in dental resins would be particularly useful.

According to a further aspect, the use is described herein of polyamides modified with amino groups from polyetheramine, having antibacterial properties together with mechanical properties that make them useful in the dental field. In these applications, according to some embodiments, the base polyamide can comprise nylon 12, instead of nylon 6 or nylon 66.

Specifically disclosed is the use of a polyamide containing nylon and polyetheramine for the production of dental articles with bacteriostatic or antibacterial properties, including antifungal properties, among which: dental splints, dental bites, dental prostheses, and components thereof.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

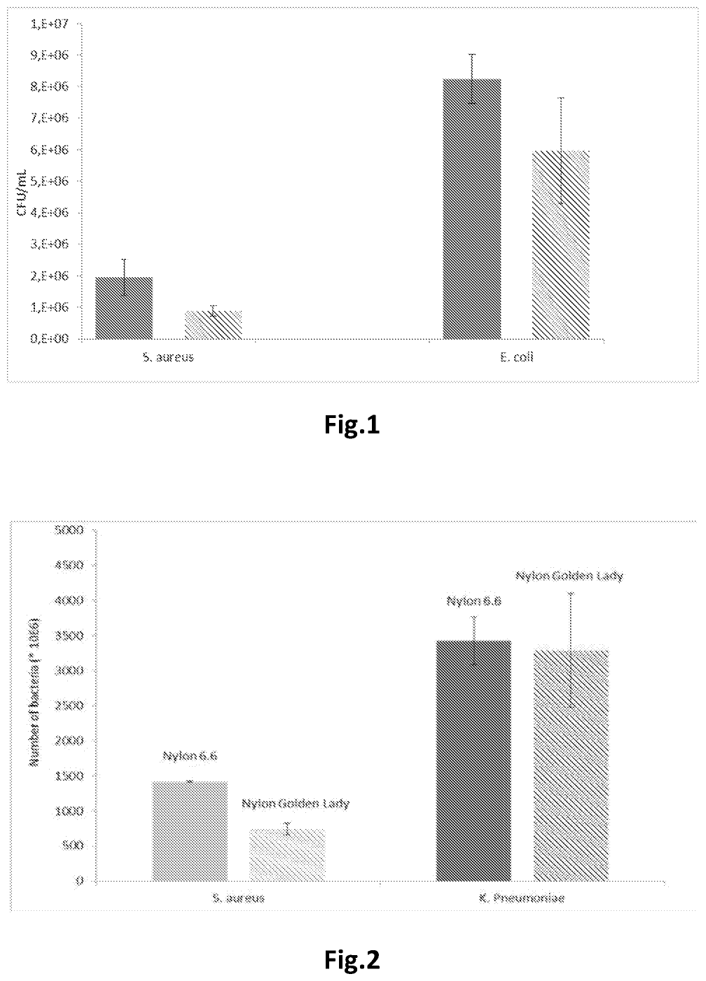

The invention will be described below with reference to a series of embodiments and the results that can be achieved by means of the invention will be illustrated in the attached drawing, where FIGS. 1 and 2 show the antibacterial properties of a fabric manufactured with a polyamide composed of nylon 66 and a polyamide containing nylon 66 and polyetherdiamine, according to the uses described herein.

### DETAILED DESCRIPTION OF AN EMBODIMENT

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

Ratios, concentrations, amounts and other figures illustrated and mentioned in the present description and in the attached claims can be expressed as ranges. It should be understood that this is done for the sake of convenience and conciseness. It should be understood that a range does not only comprise the numbers indicated as range limits. Contrariwise, a range of values shall be understood in a wide and flexible meaning as comprising all the individual numerical values contained in the range, as well as the sub-intervals thereof, delimited by any two numbers contained in the range. Therefore, the term “a range from about A to about B” refers in general not only to the range defined by the limit values A and B, but also any sub-intervals “from about X to about Y”, wherein X and Y are values contained between A and B.

When the amount of a substance A in a group B of substances is defined by means of a series of percentages of maximum values and a series of percentages of minimum values, it should be understood that the substance A can be contained in the group in an amount within a plurality of intervals each of which is defined by a pair of any minimum value and any maximum value. For example the expression “containing at least x %, preferably at least (x−n) %, and no more than y %, preferably no more than (y−m) %”, comprises the intervals [x; y], [x; (y−m)], [(x−n); y], [(x−n); (y−m)]. Each of these intervals also comprise each sub-interval defined within the maximum and minimum limits thereof.

The term “about” can include rounding to significant figures of numerical values.

The term “about” in the sense used herein when referred to a numerical value or a range of numerical values allows a degree of variability of the numerical value or interval for example within 10%, or within 5% of the indicated numerical value or of the indicated limit of a range.

The term average molecular weight (Mw) used in the present context is to be understood as weight average molecular weight (commonly abbreviated as Mw), unless otherwise specified.

According to embodiments described herein, to obtain a polyamide-based polymer, containing nylon, in particular for the production of yarns or fibers, having improved antibacterial ability, or a lower tendency to develop unpleasant odors when processed into garments and worn, a polyetheramine is used bound to the nylon molecules of the polyamide.

In general, the polyamide may be an acid (anionic) or a basic (cationic) polymer that can be dyed. In particularly advantageous embodiments, the polyamide may contain, for example, a nylon 66 (polyhexamethylene adipamide). In other embodiments, the polyamide may contain nylon 6, i.e. poly(ε-caprolactam). In further embodiments, the polyamide may be a copolymer of nylon 6 and nylon 66.

The polyamide containing polyetheramine may be provided by means of a batch or a continuous polymerization reaction, for example by mixing a diacid, a nylon salt and polyetheramine and by heating the mixture in one or more heating and cooling cycles at controlled pressures, to obtain the polymerization of the polyamide containing nylon and polyetheramine.

Examples of methods for manufacturing polyamide containing polyetheramine wherein the polyetheramine is introduced into the polyamide molecule during the polymerization step are described in WO2014/057364, whose content is integrally incorporated in the present description.

In other embodiments, the polyetheramine can be introduced into the polyamide chain after this latter has been already formed by means of any suitable polymerization process. For example, it is possible to use polyamide containing nylon and polyetheramine and to make the polyamide and the polyetheramine react in an extruder feeding a spinning system, or in a different container under controlled temperature and pressure so that end-groups of the polyamide molecules are replaced by polyetheramine molecules.

Examples of methods for manufacturing a polyamide containing nylon and polyetheramine through reaction of polyamide and polyetheramine in an extruder or other pressurized container are described in WO2015/001515, whose content is integrally incorporated in the present description.

Below, some details will be provided on possible methods for manufacturing polyamide containing nylon and polyetheramine, both through batch process and extrusion process.

Even if in the present description specific reference is made to examples, wherein a single polyetheramine is used, i.e. only one type of polyetheramine molecule, however it should be understood that in some embodiments more polyetheramines of different formula may be incorporated in the polyamide chain.

In some embodiments the polyetheramine may be a polyethermonoamine of general formula

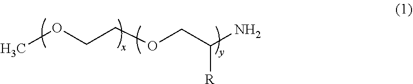

where R═H for ethylene oxide and R═CH₃ for propylene oxide, and wherein x and y vary based on the number of propylene oxides and ethylene oxides in the chain. Polyethermonoamines of formula (1) are marketed for example by Huntsman Corporation, USA, under the name Jeffamine® M series.

In preferred embodiments, the polyetheramine has more than a free NH₂ group, so that in the polymerization reaction one of the NH₂ group forms a covalent bond with the nylon 66 or the nylon 6 of the polyamide chain.

In some embodiments, the polyetheramine is a polyetherdiamine with formula

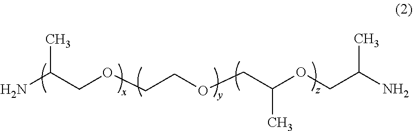

where x, y and z may vary based on the number of ethylene oxides and propylene oxides in the chain.

Polyetherdiamines of formula (2) are marketed for example by Huntsman Corporation, USA, under the name Jeffamine® ED series and Elastamine® RE series.

In preferred embodiments, the polyetheramine has an average molecular weight (Mw) equal to at least about 500, preferably equal to at least about 800, more preferably equal to at least about 1000, even more preferably equal to at least about 1500, and preferably not greater than about 5000, more preferably not greater than about 3000, for example comprised between about 1500 and about 2500.

In an embodiment, Elastamine® RE-2000 (Huntsman) or di Jeffamine® ED2003 are used, both with formula (1) where

y is equal to about 39 and

(x+z) is equal to about 6,

and having an average molecular weight (Mw) of about 2000.

In other embodiments polyetherdiamines of formula (2) may be used, with the following features:

y≅12.5; (x+z)≅6, average molecular weight Mw=900

y≅9; (x+z)≅3.6, average molecular weight Mw=600

Preferably, the polyetherdiamine has an AHEW (Amine Hydrogen Equivalent Weight) not greater than 10% with respect to the idealized AHEW. The term (AHEW) is defined as the molecular weight of the polyetheramine divided by the number of the active amine hydrogens per molecule. For example, an idealized polyetheramine having an average molecular weight of 2000 and where all the polyether end groups are amino terminals, then contributing with 4 active amino hydrogens for each molecule, would have an idealized AHEW of 500 g per equivalent. If 10% of the end groups are hydroxyl instead of amino, there will be only 3.6 amine active hydrogens per molecule and the polyetheramine will have an AHEW of 556 g per equivalent.

The number of amine active hydrogens per molecule, and therefore the AHEW of a given polyetheramine, can be calculated by means of known and conventional techniques, for example by calculating the nitrogen content of the amine groups using the procedure defined by the ISO 9702 standard.

In particularly advantageous embodiments, the polyetheramine is a polyetherdiamine, preferably having a molecular weight equal to or greater than 1500 and an AHEW not exceeding by more than 10% the idealized AHEW for said polyetherdiamine.

In embodiments described herein, the polyetherdiamine has general formula (2) and chain composition with a prevalence of PEG (polyethylene glycol) groups with respect to the PPG (polypropylene glycol) groups, i.e. with y>(x+z).

In other embodiments, the polyetherdiamine may have a chain containing polyethylene glycol (PEG) groups and polypropylene glycol (PPG) groups, the PPG groups being predominant. Polyetherdiamines of this type are marketed by Huntsman Corporation, under the trade name of Elastamine® RP series.

In further embodiments, the polyetherdiamine may have a structure based on polypropylene glycol and poly(tetramethylene ethere) glycol (PTMEG). Examples of polyetherdiamines of this type are the polyetherdiamines marketed by Huntsman Corporation under the trade name of Elastamine® RT series.

Although the polyetherdiamines of the RE series with average molecular weight equal to or greater than about 1500 and equal to or lower than about 2500 are currently preferred, in particular for the applications to polyamides for the production of fibers and yarns, it is also possible to use polyetherdiamines of higher average molecular weight, for example up to about 5000, such as Elastamine® RP3-5000 (Huntsman). In further embodiments, the polyetherdiamine may have lower molecular weights (Mw), for example

In further embodiments the polyetherdiamine has a chain consisting of PPG polypropylene glycol groups, of formula

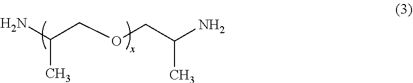

for example the polyetherdiamines of the Jeffamine® D series produced and marketed by Huntsman Corporation, with average molecular weight (Mw) ranging from about 230 to about 4000 and wherein x can range from about 2.5 to about 68.

In further embodiments, polyetheramines with a number of end amino groups (NH₂) greater than two can be used. For example, the polyetheramine can be a polyethertriamine of formula

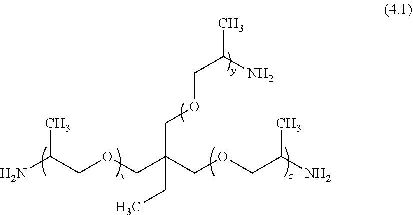

wherein (x+y+z) may be comprised between 5 and 6 and the Mw is about 440. In other embodiments, the polyethertriamine can have formula

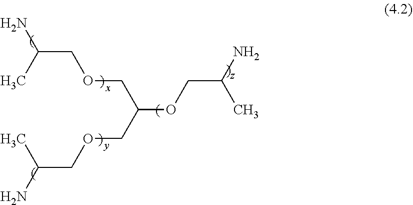

with x+y+z comprised between about 50 and about 85 for average molecular weights (Mw) increasing from about 3000 to about 5000. Polyethertriamines of this type are, for example, those of the Jeffamine® T series produced and marketed by Huntsman Corporation, USA.

The polyamides modified as described herein can be produced by means of a batch or continuous process, starting from a nylon salt, a diacid and polyetheramine. In some embodiments, the process provides for the steps of contacting the diacid, the polyetheramine and the nylon salt, forming a mixture; and of heating the mixture in a closed container at a temperature and pressure sufficient to obtain the polymerization of the mixture forming the polyamide containing nylon and polyetheramine. Nylon salt may be a nylon 66 salt (hexamethylenediamine adipate), a nylon 6 salt, or a combination thereof.

The nylon salt may be provided in an amount from about 50% by weight to about 99% by weight, preferably from about 50% by weight to about 95% by weight.

In general, the polymerization can comprise several subsequent heating cycles, with suitable pressure and temperature profiles. A more detailed description of possible polymerization cycles can be found in WO2014/057364. According to the type of nylon salt used, in general, the final polymer can be a polyamide comprising nylon 6, nylon 66 or copolymers of nylon 6 and nylon 66, in the chain of which polyetheramine molecules are present.

The finished product can be formed into chips and used in subsequent spinning processes by extrusion according to known techniques.

In further embodiments, as mentioned above, the polyetheramine can be introduced in the polyamide chain even after polymerization, for example by making polyamide containing nylon and polyetheramine react in an extruder, or in a pressurized container. Methods of this type are described in WO2015/001515.

In some embodiments, polyamide and polyetheramine are introduced in a container, with additives, if necessary, to facilitate the reaction between polyamide and polyetheramine. The polymer mass is brought to melting temperature and reacts with the polyetheramine to obtain the modified polyamide.

The additive may comprise a chain extender or a grafter for thermoplastic polymers and in particular for polyamides, suitable to react with carboxyl and amino groups. In some embodiments, the additive may be a chain extender Joncryl® ADR-3400 marketed by BASF. Other suitable additives can be Fusabond N493 produced by DuPont, Orgalloy R 6000-6600, produced by Athochem, Irgarod RA20 produced by Ciba Specialty Chemicals.

After the reaction, between polyamide and polyetheramine, the polymer can be directly extruded to obtain single- or multi-filament yarns, for the formation of yarns or fibers for the production of textile, clothing or other articles.

In embodiments described herein, the amount of polyetheramine in the polyamide may be comprised from about 1% by weight to about 50% by weight, for example from about 2% to about 30%, preferably from about 5% to about 25% by weight, for example between about 8% by weight and about 20% by weight with respect to the overall weight of the polyamide.

In some embodiments the polyamide comprises a quantity of nylon of at least 50%, preferably at least 60%, more preferably at least 70%, even more preferably at least 80%, for example at least 85% by weight with respect to the total weight of the polyamide. In some embodiments, the percentage of nylon is not greater than 99%, preferably not greater than 98%, more preferably not greater than 95%, even more preferably not greater than 90%, for example not greater than 85% by weight with respect to the total weight of the polyamide.

If the polyamide modified as described herein is used in mixture or in combination with other polymers, for example in bi-component fibers, the above indicated percentages of nylon and polyetheramine refer to the overall weight of the polyamide containing nylon and polyetheramine, excluding the weight of the second or further polymer combined thereto.

The usable polyamide can have a molecular mass comprised for example between about 8,000 and about 18,000 UMA. In some embodiments, the polyamide has a molecular mass comprised between about 9,000 and about 15,000 UMA, for example between about 10,000 and about 14,000 UMA.

In a possible embodiment, the polyamide can have a number of amino end groups (NH₂) equal to the number of carboxyl end groups (COOH), for example in both cases equal to 47.

The polyamide described herein can be advantageously used for producing semi-finished products for the textile industry, in the form of a continuous yarn or staple fiber. The yarn can be a single- or a multi-filament yarn.

The yarn can be obtained by extrusion and the stable fibers by cutting the extruded continuous yarn. The yarn obtained by extruding the polymer according to the method described herein may be a multi-filament textile yarn of the LOY (low orientation yarn) type, the POY (Partially Oriented Yarn) type, or an FDY (Fully Drawn Yarn).

If the yarn is cut into fibers, the fibers may have, for example, a length comprised between about 10 and about 100 mm. The staple fibers can be converted into continuous yarns by means of spinning processes known per se.

According to another aspect, the staple fibers can be used for the production of non-woven fabrics, forming plies of fibers that are subsequently subjected to mechanical, hydraulic, chemical, thermal bonding or a combination thereof.

The yarns can be used in weaving processes, or knitted or for other uses.

The yarns made with the process described herein can be subsequently processed to modify their physical and mechanical properties. In some embodiments, the yarns may be combined with other yarns to obtain composite products. In some embodiments, the yarns obtained from a spinneret can be textured, or taslanized, stretched, combined with elastomer yarns, for example by means of an interlacing jet, a covering jet or other suitable device.

The yarn or fiber can be single-component. In this case the filament(s) forming it are made of the same material. In other embodiments, the yarn may be multi-component, e.g. bicomponent. One, some or each filament constituting the yarn includes, in this case, two parts formed by two different polymers. In some embodiments, the filament comprises an inner core and an external coating (so-called “core-skin” bicomponent fiber) made of different polymers. According to possible embodiments, the outer part, or skin, which surrounds the inner core can be made with the high moisture regain polymer containing polyamide and polyetheramine, while the core can be made with a different polymer, for example in a polyamide without polyetheramine molecules. In some embodiments, a core of nylon 6 or nylon 66 can be extruded with a polyamide and polyetheramine skin produced as described herein.

In some embodiments the bicomponent fiber may have a second component constituted by or comprising polypropylene, or thermoplastic polyurethane, or polyester, for example polyethylene terephthalate or polybutylene terephthalate.

In other embodiments the two components forming each filament can be arranged side by side (so-called “side-by-side” bicomponent fibers) rather than inserted one into the other.

Extrusion heads for the production of multi-component fibers, in particular bicomponent fibers, are known per se and can be used advantageously in the context of the present method.

In some embodiments, bi-component yarns may be manufactured wherein from 10% to 95% by weight, preferably from 50% to 80% by weight of the polymer composing them is a polymer containing polyamide and polyetheramine, while the remaining part is constituted by unmodified polyamide, i.e. polyamide without polyetheramine, and made for example only of nylon, or of a polymer of different nature, for example polypropylene.

In some embodiments, the yarn is extruded with a number of filaments comprised between 1 and 300, for example between 5 and 200.

In some embodiments, the yarn has a yarn count comprised between 5 and 6000 Dtex. In advantageous embodiments the yarn has DPF value (dtex per filament) comprised between 0.5 and 20.

In some particularly advantageous embodiments, the yarn has a number of filaments comprised between 1 (single-filament) and 100, preferably between 30 and 60 and a titer comprised between 7 and 140 dtex, preferably between 40 and 60 dtex. In some embodiments, the polymer is extruded at an extrusion rate between 20 and 80 cm/s. The filaments exiting from the spinneret can advantageously be cooled in a known way, for example in an air stream.

In this step the individual filaments are cooled with a lateral flow of air and made converge towards and through an oiler to be then joined to form a multi-filament yarn. Downstream, the yarn can be driven around one or more stretching and/or relaxation and/or stabilizing rollers, motorized and controlled at peripheral speeds which can be different from each other to impart to the yarn the required and desired degree of stretching and/or orientation.

In some embodiments, the yarn is subjected to an elongation comprised between 20% and 60%.

Finally, the yarn is wound to form a reel or pack. The winding speed can be, for example, comprised between 1000 and 5500 m/min.

### Test on Antibacterial Features

The comparative tests described below have been conducted on the anti-bacterial properties of the polyamide containing polyetheramine.

Fabric samples have been knitted on a circular machine with a multi-filament yarn in polyamide 66 with a count of 46 dtex and 40 filaments and fabric samples have been knitted on a circular machine with multi-filament yarn (count 46 dtex and 40 filaments) of polyamide 66 modified with the polyetherdiamine Elastamine® RE2000 (Huntsman) in an amount equal to 8% wt with respect to the total weight of the yarn.

The fabric samples have been seeded with the following microorganisms according to the standard ISO 20743:2013:
gram-positive bacterium Staphylococcus aureus (DSM 346)
gram-negative bacterium Klebsiella pneumoniae (DSM 789) and with the following microorganisms according to ASTM E2315-03
gram-positive bacterium Staphylococcus aureus (DSM 346);
gram-negative bacterium Escherichia coli (DSM 1576),

FIG. 1 shows the results according to ISO 20743:2013, FIG. 2 shows the results according to ASTM E2315-03. For each microorganism the number is indicated of micro-organisms (in 10⁶) detected for nylon 66 and for the modified polyamide containing nylon 66 and the polyetherdiamine Elastamine® RE2000 (Huntsman) in an amount equal to 8% wt with respect to the overall weight of the yarn. As shown in FIG. 1, according to the ISO test, the fabric sample made with the modified polyamide containing polyetherdiamine has an antibacterial activity
of 40% with respect to Staphylococcus aureus, i.e. the proliferation of the bacterial population is 40% lower than that on the reference fabric, made of the same polyamide but without polyetheramine;
of 4% with respect to Klebsiella pneumoniae, i.e. the proliferation of the bacterial population is 4% lower than that on the reference fabric, made of the same polyamide but without polyetheramine.

According to the ASTM test, FIG. 2, the sample of fabric made with the modified polyamide containing polyetherdiamine has antibacterial activity
of 50% with respect to Staphylococcus aureus, i.e. the proliferation of the bacterial population is 50% lower than that on the reference fabric, made of the same polyamide but without polyetheramine;
of 30% with respect to Escherichia coli, i.e. the proliferation of the bacterial population is 30% lower than that on the reference fabric, made of the same polyamide by without polyetheramine;

In both figures the data indicated have been obtained after 24 hours from the inoculation of the microorganism and, for each micro-organism, in each figure, two histograms are represented: the left one refers to the reference sample, made of yarns of standard polyamide (nylon 66), while the right one refers to the sample made with the modified polyamide containing polyetheramine.

It is important to note that the international testing standards used only establish the procedure to be followed to carry out the test. They do not provide any absolute, or even relative, benchmarks to define whether the activity found is weak, good or excellent. This parameter must be defined on the basis of the properties of the final product (for example the emission of fabric odors), which it is ultimately necessary to compare.

According to the above data, it is possible to state that the fabrics made using fibers that have been chemically modified by inserting polyetheramine feature a reduced proliferation of bacteria on the fabric with respect to the same fabrics made with standard fiber (nylon 66). The antibacterial activity has been confirmed by means of two different types of test (ISO and ASTM). In fact, for the polyamide-based fabrics compared, activity of 40% and 50% have been measured with respect to the Staphylococcus aureus, values which are comparable. It shall be also specified that the bacterium Klebsiella pneumoniae is a particularly resistant bacterium, difficult to be killed. Therefore, obviously, lower activity values have been obtained than those obtained with respect to other bacterial strains.

Finally, not all bacterial colonies are equivalent as regards their ability to generate unpleasant odors. With regard to this indicator, particularly relevant tests are those for Escherichia coli.

The tests carried out show that the introduction of polyetheramine molecules in the nylon chain allows substantial improvements in the polymer as regards the antibacterial activity thereof.

The increased antibacterial activity resulting from the modification of the polyamide by the insertion of polyetheramine in the polymer chain allows to obtain a polymeric filament material, i.e. suitable to cause the formation of multi- or single-filament yarns, that can be in turn transformed into staple fibers which can be advantageously used in the manufacture of textile articles, by converting the fiber or yarn into fabrics or non-woven fabrics. These textile articles can be advantageously used in the clothing field, especially in sportswear, thanks to their ability to reduce the formation of bad smell due to bacterial proliferation. The antibacterial activity results, in fact, in a reduced proliferation of microorganisms responsible for the generation of bad smell. Moreover, the modified polymer can be advantageously used even when a reduction of the bacterial charge is required, i.e. a reduction in the amount of micro-organisms, also for hygienic and sanitary reasons. Textile materials using modified polyamide as disclosed herein, with improved antibacterial properties, can be used for example in the production of coats, pajamas, sheets, drapes, protective masks, pillowcases, blankets, curtains, bandages, and other articles, especially for hospital uses.

For example, the polyamide containing nylon and polyetheramine to impart or increase antibacterial properties may be used in medical fields, for all the uses for which polyamide is generally used. For example, polyetheramine can be used to impart antibacterial properties to polyamides intended for the production of yarns and membranes for medical use, such as suture yarns, balloon membranes for angioplasty catheters (also in the form of nylon 11 and nylon 12), bandages and medical film, hemodialysis membranes, tendon and ligament reconstruction materials. Modified polyamide as described herein, for example, modified polyamide 12 (nylon 12) can be used for the production of articles for dental use, in particular: dental splints, dental bites, dental apparatus, dentures, fixed or mobile dental prostheses, and parts of these articles.

1. A method comprising providing a polyetheramine in a polyamide containing nylon to impart, or increase, anti-bacterial properties of polyamide.

2. A method according to claim 1, wherein the polyetheramine is a polyetherdiamine or a polyethertriamine.

3. A method according to claim 1, wherein nylon is selected from the group consisting of: nylon 6; nylon 66; nylon 12; a copolymer containing at least two components selected from nylon 6, nylon 66, nylon 12; or combinations thereof.

4. A method according to claim 1, wherein the polyetheramine is mainly positioned as a chain terminals in the polyamide, with a free amino-group (NH₂).

5. A method according to claim 1, wherein the weight percentage of polyetheramine is comprised of about 1% and about 50% of total weight of the polyimide.

6. A method according to claim 1, wherein the polyamide comprises a weight percentage of nylon between about 50% and about 95% of the total weight of the polyamide.

7. A method according to claim 1, wherein polyetheramine has an average molecular weight (Mw) of between about 500 and about 5000.

8. A method according to claim 1, further comprising manufacturing a semi-finished product for the production of textile articles, said semi-finished product being selected from the group consisting of: staple fibers; continuous single-filament yarns; continuous multi-filament yarns.

9. A method according to claim 8, wherein said semi-finished product is a bicomponent semi-finished product.

10. A method according to claim 9, wherein the bicomponent semi-finished product comprises a weight percentage of polyamide of at least about 10%, and not greater than about 95% of the total weight of the semi-finished product.

11. A method comprising providing a polyamide yarn or fiber comprising nylon and at least one polyetheramine for the production of a textile article with anti-bacterial properties.

12. A method according to claim 11, wherein the textile article is selected from the group comprising: a non-woven constituted by bonded fibers; a woven fabric; a knitted fabric; or combinations thereof.

13. A method according to claim 11, wherein the polyetheramine is a polyetherdiamine or a polyethertriamine.

14. A method according to claim 11, wherein nylon is nylon 6, or nylon 66, or a copolymer of nylon 6 and nylon 66.

15. A method according to claim 11, wherein the polyetheramine is mainly positioned as a chain terminal in the polyamide, with a free amino-group (NH₂).

16. A method according to claim 11, wherein the weight percentage of polyetheramine is between about 1%, and about 50% of the total weight of the polyamide.

17. A method according to claim 11, wherein the polyamide comprises a weight percentage of nylon between about 50% and about 99% of the total weight of the polyamide.

18. A method according to claim 11, wherein the polyetheramine has an average molecular weight (Mw) between about 500 and about 5000.

19. A method according to claim 11, wherein said fiber or yarn has a bicomponent structure, wherein one of the component thereof is said polyamide comprising nylon and a polyetheramine.

20. A method according to claim 19, wherein the bicomponent fiber or yarn comprises a weight percentage of said polyamide comprising nylon and a polyetheramine between about 10% and about 95% of the total weight of the bicomponent fiber or yarn.

21. A method according to claim 2, wherein nylon is selected from the group consisting of: nylon 6; nylon 66; nylon 12; a copolymer containing at least two components selected from nylon 6, nylon 66, nylon 12; or combinations thereof.

22. A method according to claim 2, wherein the polyetheramine is mainly positioned as a chain terminals in the polyamide, with a free amino-group (NH₂).

23. A method according to claim 3, wherein the polyetheramine is mainly positioned as a chain terminals in the polyamide, with a free amino-group (NH₂).

24. A method according to claim 4, wherein the polyetheramine is mainly positioned as a chain terminals in the polyamide, with a free amino-group (NH₂).

25. A method according to claim 1, wherein the weight percentage of polyetheramine is between about 10% and about 20% of the total weight of the polyamide.

26. A method according to claim 2, wherein the weight percentage of polyetheramine is between about 1% and about 50% of the total weight of the polyamide.

27. A method according to claim 2, wherein the weight percentage of polyetheramine is between about 10% and about 25% of the total weight of the polyamide.

28. A method according to claim 1, wherein the polyamide comprises a weight percentage of nylon of between about 80% and about 95% of the total weight of the polyamide

29. A method according to claim 1, wherein polyetheramine has an average molecular weight (Mw) of between preferably of at least about 800 and 5000.

30. A method according to claim 1, wherein polyetheramine has an average molecular weight (Mw) of between about more preferably of at least about 1000 and 3000.

31. A method according to claim 1, wherein polyetheramine has an average molecular weight (Mw) of between about, even more preferably of at least about 1500 and 3000.

32. A method according to claim 11, wherein the weight percentage of polyetheramine is between about 10% and about 20% of the total weight of the polyamide.

33. A method according to claim 11, wherein the polyamide comprises a weight percentage of nylon of between about 80% and about 90% of the total weight of the polyamide.

34. A method according to claim 11, wherein the polyetheramine has an average molecular weight (Mw) between about 1500 and about 3000.

35. A method according to claim 20, wherein the bicomponent fiber or yarn comprises a weight percentage of said polyamide comprising nylon and a polyetheramine of between about 50% and about 80% of the total weight of the bicomponent fiber or yarn.
